(19) United States
(12) Patent Application Publication
(10) Pub. No.: US 2017/0203645 A1
(43) Pub. Date: Jul. 20, 2017

(54) HYBRID WORK MACHINE CONTROL DEVICE, HYBRID WORK MACHINE, AND HYBRID WORK MACHINE CONTROL METHOD

(71) Applicant: Komatsu Ltd., Tokyo (JP)

(72) Inventors: Tomotaka Imai, Tokyo (JP); Masaru Shizume, Tokyo (JP)

(21) Appl. No.: 15/124,474

(22) PCT Filed: Jan. 20, 2016
(86) PCT No.: PCT/JP2016/051623

§ 371 Date: Sep. 8, 2016

(51) Int. Cl. B60K 6/46; B60W 10/06; B60W 20/00; B60K 6/24; F02D 41/02; F02D 29/06; B60L 11/12; B60W 10/08; F01N 9/00

(52) U.S. Cl. CPC B60K 6/46; B60W 10/08; B60W 10/06; B60W 20/00; F01N 9/002; F02D 41/0205; F02D 29/06; B60L 11/12; B60K 6/24; B60W 2300/17; B60W 2710/06; B60W 2710/08; B60Y 2400/43; B60Y 2200/92

(57) ABSTRACT

A control method for a hybrid work machine including an internal combustion engine which includes an exhaust gas treatment device, a generator motor which is connected to an output shaft of the internal combustion engine, and an electrical storage device which stores electric power generated by the generator motor or supplies electric power to the generator motor, the control method for the hybrid work machine includes: determining whether the hybrid work machine is in a regeneration state in which a regeneration is performed by the exhaust gas treatment device; setting a threshold value for starting a generation of power by the generator motor to a minimum generation torque as a lower limit value when it is determined that the exhaust gas treatment device performs a regeneration; and controlling the generator motor based on the set threshold value.

### FIELD

The present invention relates to a technique of controlling a hybrid work machine including an internal combustion engine with an exhaust gas treatment device.

### BACKGROUND

A work machine includes, for example, an internal combustion engine as a power source which generates power for a traveling operation or power for operating a working implement. In recent years, for example, as disclosed in Patent Literature 1, there is known a hybrid work machine using a combination of an internal combustion engine and a generator motor. Here, power generated by the internal combustion engine is used to operate the work machine and the generator motor is driven by the internal combustion engine so as to generate electric power.

The internal combustion engine includes an exhaust gas treatment device which reduces the amount of NOx (nitrogen oxides) contained in an exhaust gas. For example, as disclosed in Patent Literature 2, the exhaust gas treatment device includes a particle trapping filter which traps particles such as soot contained in an exhaust gas and a reducing catalyst which reduces NOx. When the amount of trapped PM or absorbed NOx increases, the filtering functions and the absorbing performance of the particle trapping filter and the reducing catalyst are degraded. For this reason, a regeneration process is performed in order to recover the filtering functions and the absorbing performance. For example, the particle trapping filter is regenerated by burning the trapped particles by the exhaust gas.

### CITATION LIST

### Patent Literatures

Patent Literature 1: Japanese Laid-open Patent Publication No. 2012-241585

Patent Literature 2: Japanese Laid-open Patent Publication No. 2013-015064

### SUMMARY

### Technical Problem

When the particle trapping filter is regenerated, there is a need to maintain the rotation speed of the internal combustion engine at a predetermined rotation speed in order to appropriately maintain the temperature and the flow rate of the exhaust gas. For this reason, there is a need to prevent a change in the rotation speed of the internal combustion engine with respect to a predetermined rotation speed in the regeneration process.

An object of an aspect of the invention is to suppress a change in the rotation speed of the internal combustion engine in the regeneration process in the hybrid work machine including the internal combustion engine with the exhaust gas treatment device.

### Solution to Problem

According to a first aspect of the present invention, a control device for a hybrid work machine including an internal combustion engine which includes an exhaust gas treatment device, a generator motor which is connected to an output shaft of the internal combustion engine, and an electrical storage device which stores electric power generated by the generator motor or supplies electric power to the generator motor, the control device controlling the hybrid work machine comprises: a determination unit which determines whether the hybrid work machine is in a regeneration state in which a regeneration is performed by the exhaust gas treatment device; a threshold value setting unit which sets a threshold value for starting a generation of power by the generator motor to a minimum generation torque as a lower limit value when the determination unit determines that the regeneration is performed by the exhaust gas treatment device; and a generation control unit which controls the generator motor based on the threshold value set by the threshold value setting unit.

According to a second aspect of the present invention, a control device for a hybrid work machine including an internal combustion engine which includes an exhaust gas treatment device, a generator motor which is connected to an output shaft of the internal combustion engine, and an electrical storage device which stores electric power generated by the generator motor or supplies electric power to the generator motor, the control device controlling the hybrid work machine comprises: a determination unit which determines whether the hybrid work machine is in a regeneration state in which a regeneration is performed by the exhaust gas treatment device; a threshold value setting unit which sets a charging request voltage value as a threshold value for starting a charging of the electrical storage device to a predetermined first voltage value when the determination unit determines that the exhaust gas treatment device stops the regeneration and sets the charging request voltage value to a second voltage value higher than the first voltage value when the determination unit determines that the exhaust gas treatment device performs the regeneration; and a generation control unit which controls the generator motor based on the charging request voltage value set in the threshold value setting unit.

According to a third aspect of the present invention, in the control device for the hybrid work machine according to the second aspect, the second voltage value is a voltage value charged when the generator motor generates power at a generation torque of a lower-limit setting value.

According to a fourth aspect of the present invention, in the control device for the hybrid work machine according to any one of the aspects 1 to 3, the determination unit determines the regeneration state when a predetermined regeneration instruction is input, a particle accumulation amount of the exhaust gas treatment device is equal to or larger than a predetermined value, a rotation speed instruction value for instructing a rotation speed of the internal combustion engine is smaller than a predetermined value, a rotation speed difference between the rotation speed of the internal combustion engine and the rotation speed instruction value is within a predetermined rotation speed, and the hybrid work machine prohibits an operation of a working implement.

According to a fifth aspect of the present invention, in the control device for the hybrid work machine according to any one of the aspects 1 to 4, the control device for the hybrid work machine further comprises: a rotation speed control unit which controls a rotation speed of the internal combustion engine based on a load of a working implement provided in the hybrid work machine.

According to a sixth aspect of the present invention, a hybrid work machine comprises: an internal combustion engine which includes an exhaust gas treatment device; a generator motor which is connected to an output shaft of the internal combustion engine; an electrical storage device which stores electric power generated by the generator motor or supplies electric power to the generator motor; and the control device for the hybrid work machine according to any one of aspects 1 to 5 which controls the internal combustion engine, the generator motor, and the electrical storage device.

According to a seventh aspect of the present invention, a control method for a hybrid work machine including an internal combustion engine which includes an exhaust gas treatment device, a generator motor which is connected to an output shaft of the internal combustion engine, and an electrical storage device which stores electric power generated by the generator motor or supplies electric power to the generator motor, the control method for the hybrid work machine comprises: determining whether the hybrid work machine is in a regeneration state in which a regeneration is performed by the exhaust gas treatment device; setting a threshold value for starting a generation of power by the generator motor to a minimum generation torque as a lower limit value when it is determined that the exhaust gas treatment device performs a regeneration; and controlling the generator motor based on the set threshold value.

### Advantageous Effects of Invention

According to an aspect of the invention, it is possible to suppress a change in the rotation speed of the internal combustion engine in the regeneration process in the hybrid work machine including the internal combustion engine with the exhaust gas treatment device.

### BRIEF DESCRIPTION OF DRAWINGS

FIG. 1 is a perspective view illustrating an excavator as a work machine according to an embodiment.

FIG. 2 is a schematic diagram illustrating a drive system of the excavator according to the embodiment.

FIG. 3 is a schematic diagram illustrating an exhaust gas treatment device according to the embodiment.

FIG. 4 is a diagram illustrating an example of a torque chart used to control an engine according to the embodiment.

FIG. 5 is a diagram illustrating a configuration example of a hybrid controller.

FIG. 6 is a control block diagram of a generation control unit of the hybrid controller.

FIG. 7 is a diagram illustrating an example of a calculation block of a generation deceleration state determination unit.

FIG. 8 is a diagram illustrating an example of a calculation block of a processing unit.

FIG. 9 is a diagram illustrating an example of a calculation block of a processing unit.

FIG. 10 is a flowchart illustrating an example of a method of controlling an engine of a hybrid work machine according to the embodiment.

FIG. 11 is a diagram illustrating a calculation block of a generation deceleration state determination unit according to a modified example.

FIG. 12 is a diagram illustrating an example of a calculation block of a processing unit according to the modified example.

FIG. 13 is a flowchart illustrating an example of a method of controlling an engine of a hybrid work machine according to the modified example.

FIG. 14 is a diagram illustrating a change in capacitance with time in a rotation deceleration mode.

FIG. 15 is a diagram illustrating a change in generation torque with time in a rotation deceleration mode.

FIG. 16 is a diagram illustrating a change in capacitance with time in a fixed manual regeneration mode.

FIG. 17 is a diagram illustrating a change in generation torque with time in a fixed manual regeneration mode.

### DESCRIPTION OF EMBODIMENTS

A mode for carrying out the invention (an embodiment) will be described in detail with reference to the drawings.

<Overall Configuration of Work Machine>

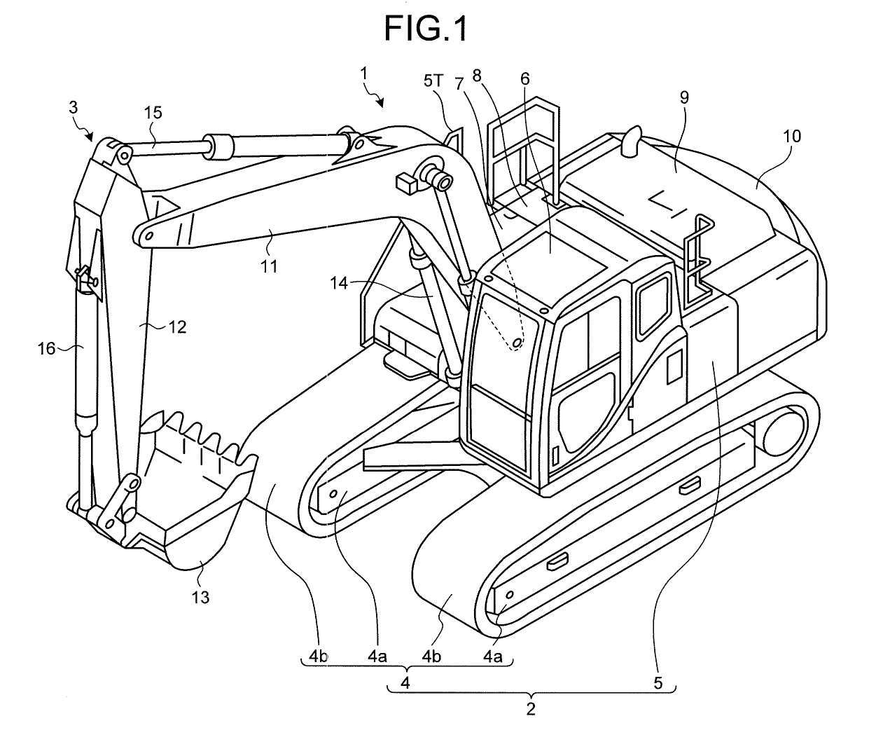

FIG. 1 is a perspective view illustrating an excavator 1 as a work machine according to the embodiment. The excavator 1 includes a vehicle body 2 and a working implement 3. The vehicle body 2 includes a lower traveling body 4 and an upper swinging body 5. The lower traveling body 4 includes a pair of traveling devices 4a, 4a. The traveling devices 4a, 4a respectively include crawlers 4b, 4b. Each of the traveling devices 4a, 4a includes a traveling motor 21. The traveling motor 21 illustrated in FIG. 1 drives the left crawler 4b. Although not illustrated in FIG. 1, the excavator 1 also includes a traveling motor which drives the right crawler 4b. The traveling motor which drives the left crawler 4b will be referred to as a left traveling motor, and the traveling motor which drives the right crawler 4b will be referred to as a right traveling motor. When the right traveling motor and the left traveling motor respectively drive the crawlers 4b and 4b, the excavator 1 is caused to travel or swing.

The upper swinging body 5 as an example of a swinging body is provided on the lower traveling body 4 in a swingable manner. The excavator 1 is swung by a swinging motor for swinging the upper swinging body 5. The swinging motor may be an electric motor which converts electric power into rotation power, a hydraulic motor which converts the pressure (hydraulic pressure) of hydraulic oil into rotation power, or a combination of the hydraulic motor and the electric motor. In the embodiment, the swinging motor is an electric motor.

The upper swinging body 5 includes a cabin 6. Further, the upper swinging body 5 includes a fuel tank 7, a hydraulic oil tank 8, an engine room 9, and a counter weight 10. The fuel tank 7 stores fuel for driving an engine. The hydraulic oil tank 8 stores hydraulic oil which is ejected from a hydraulic pump to a hydraulic cylinder like a boom cylinder 14, an arm cylinder 15, and a bucket cylinder 16 and a hydraulic device like the traveling motor 21. The engine room 9 stores devices including an engine which serves as a power source of the excavator and a hydraulic pump which supplies hydraulic oil to the hydraulic device. The counter weight 10 is disposed at the rear side of the engine room 9. A rail ST is attached to the upper part of the upper swinging body 5.

The working implement 3 is attached to the front center position of the upper swinging body 5. The working implement 3 includes a boom 11, an arm 12, a bucket 13, the boom cylinder 14, the arm cylinder 15, and the bucket cylinder 16. The base end of the boom 11 is connected to the upper swinging body 5 by a pin. With such a structure, the boom 11 is operated with respect to the upper swinging body 5.

The boom 11 is connected to the arm 12 by a pin. More specifically, the front end of the boom 11 is connected to the base end of the arm 12 by a pin. The front end of the arm 12 is connected to the bucket 13 by a pin. With such a structure, the arm 12 is operated with respect to the boom 11. Further, the bucket 13 is operated with respect to the arm 12.

The boom cylinder 14, the arm cylinder 15, and the bucket cylinder 16 are hydraulic cylinders which are driven by the hydraulic oil ejected from the hydraulic pump. The boom cylinder 14 operates the boom 11. The arm cylinder 15 operates the arm 12. The bucket cylinder 16 operates the bucket 13.

<Drive System 1PS of Excavator 1>

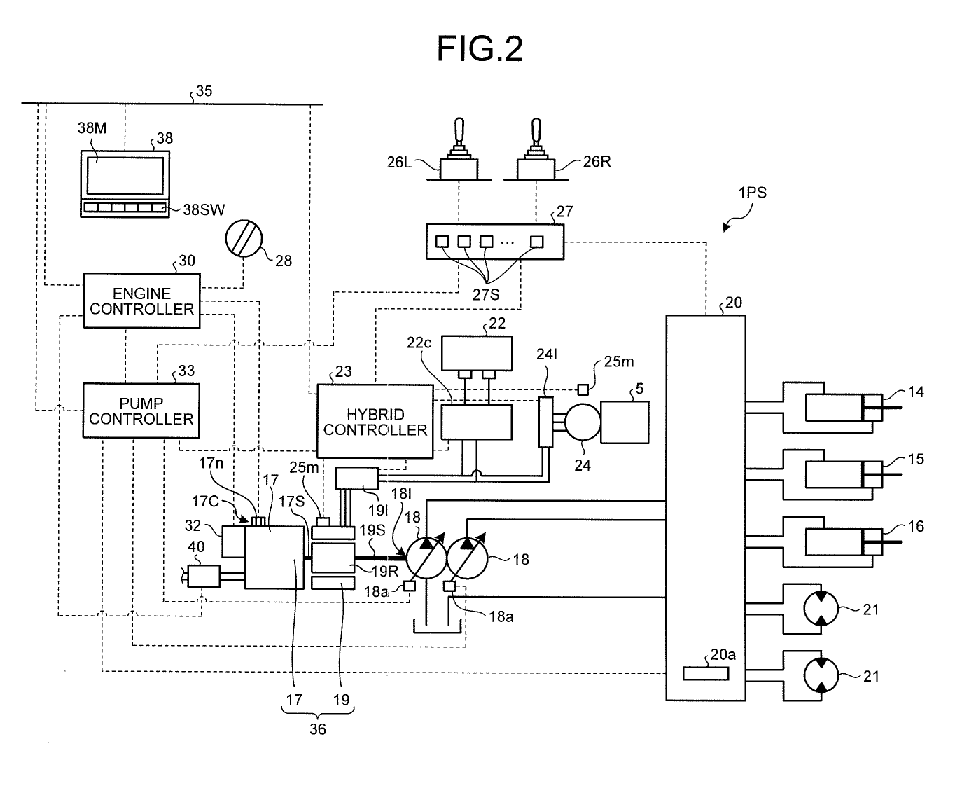

FIG. 2 is a schematic diagram illustrating a drive system of the excavator 1 according to the embodiment. In the embodiment, the excavator 1 is a hybrid work machine including a combination of an internal combustion engine 17, a generator motor 19 which generates power while being driven by the internal combustion engine 17, an electrical storage device 22 which stores electric power, and a motor which is driven by the supply of the power generated by the generator motor 19 or the power discharged from the electrical storage device 22. More specifically, the upper swinging body 5 of the excavator 1 is swung by a motor 24 (hereinafter, appropriately referred to as a swinging motor 24).

The excavator 1 includes the internal combustion engine 17, a hydraulic pump 18, the generator motor 19, and the swinging motor 24. The internal combustion engine 17 is a power source of the excavator 1. In the embodiment, the internal combustion engine 17 is a diesel engine. The generator motor 19 is connected to an output shaft 17S of the internal combustion engine 17. With such a structure, the generator motor 19 generates electric power while being driven by the internal combustion engine 17. Further, the generator motor 19 assists the internal combustion engine 17 while being driven by the electric power supplied from the electrical storage device 22 when the power generated by the internal combustion engine 17 is not sufficient.

In the embodiment, the internal combustion engine 17 is a diesel engine, but the invention is not limited thereto. The generator motor 19 is, for example, an SR (switched reluctance) motor, but the invention is not limited thereto. In the embodiment, the generator motor 19 has a structure in which a rotor 19R is directly connected to the output shaft 17S of the internal combustion engine 17, but the invention is not limited to this structure. For example, the generator motor 19 may have a structure in which the rotor 19R is connected to the output shaft 17S of the internal combustion engine 17 through a PTO (Power Take Off). The rotor 19R of the generator motor 19 may be driven by the internal combustion engine 17 while being connected to a transmission member such as a decelerator connected to the output shaft 17S of the internal combustion engine 17. In the embodiment, the combination of the internal combustion engine 17 and the generator motor 19 becomes a power source of the excavator 1. The combination of the internal combustion engine 17 and the generator motor 19 will be appropriately referred to as an engine 36. The engine 36 is a hybrid engine which is obtained by the combination of the internal combustion engine 17 and the generator motor 19 so as to generate power necessary for the excavator 1 as the work machine.

The hydraulic pump 18 supplies hydraulic oil to the hydraulic device. In the embodiment, for example, a variable displacement hydraulic pump such as a swash plate type hydraulic pump is used as the hydraulic pump 18. An input part 18I of the hydraulic pump 18 is connected to a power transmission shaft 19S connected to the rotor of the generator motor 19. With such a structure, the hydraulic pump 18 is driven by the internal combustion engine 17.

A drive system 1PS includes an electrical storage device 22 and a swinging motor control device 24I as an electric drive system for driving the swinging motor 24. In the embodiment, the electrical storage device 22 is a capacitor, that is, an electric double layer capacitor, but the invention is not limited thereto. For example, a secondary battery such as a nickel-hydrogen battery, a lithium ion battery, and a lead storage battery may be used. The swinging motor control device 24I is, for example, an inverter. For example, the target voltage value of the electrical storage device 22 is controlled so as to ensure electric power necessary for a swinging operation during the operation of the excavator 1.

The electric power generated by the generator motor 19 or the electric power discharged from the electrical storage device 22 is supplied to the swinging motor 24 through an electric power cable so as to swing the upper swinging body 5 illustrated in FIG. 1. That is, the swinging motor 24 swings the upper swinging body 5 by performing a power running operation through the electric power supplied (generated) from the generator motor 19 or the electric power supplied (discharged) from the electrical storage device 22. The swinging motor 24 supplies (charges) electric power to the electrical storage device 22 by performing a regeneration operation when the speed of the upper swinging body 5 decreases. Further, the generator motor 19 supplies (charges) the electric power generated therefrom to the electrical storage device 22. That is, the electrical storage device 22 can store the electric power generated by the generator motor 19.

The generator motor 19 generates electric power while being driven by the internal combustion engine 17 or drives the internal combustion engine 17 while being driven by the electric power supplied from the electrical storage device 22. A hybrid controller 23 controls the generator motor 19 through a generator motor control device 19I. That is, the hybrid controller 23 generates a control signal for driving the generator motor 19 and gives the control signal to the generator motor control device 19I. The generator motor control device 19I generates electric power in the generator motor 19 (for a regeneration operation) or generates power in the generator motor 19 (for a power running operation) based on the control signal. The generator motor control device 19I is, for example, an inverter.

The generator motor 19 is provided with a rotation sensor 25m. The rotation sensor 25m detects the rotation speed of the generator motor 19, that is, the engine speed of the rotor 19R per unit time. The rotation sensor 25m converts the detected rotation speed into an electric signal and outputs the electric signal to the hybrid controller 23. The hybrid controller 23 acquires the rotation speed of the generator motor 19 detected by the rotation sensor 25m and uses the rotation speed for the control of the operation state of the generator motor 19 and the internal combustion engine 17. As the rotation sensor 25m, for example, a resolver or a rotary encoder is used. In the embodiment, when the PTO or the like is interposed between the generator motor 19 and the internal combustion engine 17, the rotation speed of the generator motor 19 and the rotation speed of the internal combustion engine 17 have a certain ratio due to the gear ratio of the PTO or the like. In the embodiment, the rotation sensor 25m may detect the engine speed of the rotor 19R of the generator motor 19 and the hybrid controller 23 may convert the engine speed into a rotation speed. In the embodiment, the rotation speed of the generator motor 19 can be substituted for a value detected by a rotation speed detection sensor 17n of the internal combustion engine 17. The generator motor 19 and the internal combustion engine 17 may be directly connected to each other without the PTO or the like.

The swinging motor 24 is provided with the rotation sensor 25m. The rotation sensor 25m detects the rotation speed of the swinging motor 24. The rotation sensor 25m converts the detected rotation speed into an electric signal and outputs the electric signal to the hybrid controller 23. As the swinging motor 24, for example, an embedded magnet synchronous motor is used. As the rotation sensor 25m, for example, a resolver or a rotary encoder is used.

The hybrid controller 23 acquires signals of detection values by temperature sensors such as thermistors or thermocouples provided in the generator motor 19, the swinging motor 24, the electrical storage device 22, a booster 22c, the swinging motor control device 24I, and the generator motor control device 19I to be described later. Based on the acquired temperature, the hybrid controller 23 manages the temperature of each of devices including the electrical storage device 22 and controls the charging/discharging operation of the electrical storage device 22, the generating operation of the generator motor 19, the assisting operation of the internal combustion engine 17, and the power running operation and the regeneration operation of the swinging motor 24. Further, the hybrid controller 23 performs an engine control method according to the embodiment.

The drive system 1PS includes operation levers 26R, 26L which are provided at the left and right positions with respect to an operator sitting position inside the cabin 6 provided in the vehicle body 2 illustrated in FIG. 1. The operation levers 26R, 26L are used for the operation of the working implement 3 and the traveling operation of the excavator 1. The operation levers 26R, 26L are respectively operated so as to operate the working implement 3 and the upper swinging body 5.

A pilot hydraulic pressure is generated based on the operation amounts of the operation levers 26R, 26L. The pilot hydraulic pressure is supplied to a control valve to be described later. The control valve drives a spool of the working implement 3 in response to the pilot hydraulic pressure. In accordance with the movement of the spool, hydraulic oil is supplied to the boom cylinder 14, the arm cylinder 15, and the bucket cylinder 16. As a result, for example, the up/down movement of the boom 11 is performed in response to the forward/backward operation of the operation lever 26R, and the excavating/dumping operation of the bucket 13 is performed in response to the left/right operation of the operation lever 26R. Further, for example, the dumping/excavating operation of the arm 12 is performed in response to the forward/backward operation of the operation lever 26L. Further, the operation amounts of the operation levers 26R, 26L are converted into electric signals by a lever operation amount detection unit 27. The lever operation amount detection unit 27 includes a pressure sensor 27S. The pressure sensor 27S detects a pilot hydraulic pressure generated in response to the operation of the operation levers 26L and 26R. The pressure sensor 27S outputs a voltage corresponding to the detected pilot hydraulic pressure. The lever operation amount detection unit 27 obtains a lever operation amount by converting the voltage output from the pressure sensor 27S into the operation amount.

The lever operation amount detection unit 27 outputs the lever operation amount as an electric signal to at least one of a pump controller 33 and the hybrid controller 23. When the operation levers 26L and 26R are electric levers, the lever operation amount detection unit 27 includes an electric detection device such as a potentiometer. The lever operation amount detection unit 27 obtains a lever operation amount by converting a voltage generated by the electric detection device in response to the lever operation amount into the lever operation amount. As a result, for example, the swinging motor 24 is driven in the left and right swinging direction by the left/right operation of the operation lever 26L. Further, the traveling motor 21 is driven by left and right traveling levers (not illustrated).

A fuel adjustment dial 28 is provided inside the cabin 6 illustrated in FIG. 1. Hereinafter, the fuel adjustment dial 28 will be appropriately referred to as the throttle dial 28. The throttle dial 28 sets a fuel supply amount to the internal combustion engine 17. The setting value (also referred to as the instruction value) of the throttle dial 28 is converted into an electric signal and is output to a control device (hereinafter, appropriately referred to as an engine controller) 30 of the internal combustion engine. By the throttle dial 28, the engine speed of the internal combustion engine 17 is set.

The engine controller 30 acquires output values of sensors detecting the rotation speed and the water temperature of the internal combustion engine 17 from sensors 17C detecting the state of the internal combustion engine 17. Then, the engine controller 30 controls the output of the internal combustion engine 17 by detecting the state of the internal combustion engine 17 from the output values of the sensors 17C and adjusting the fuel injection amount to the internal combustion engine 17. In the embodiment, the engine controller 30 includes a computer including a processor such as a CPU and a memory.

The engine controller 30 generates a signal of a control instruction for controlling the operation of the internal combustion engine 17 based on the setting value of the throttle dial 28. The engine controller 30 transmits the generated control signal to a common rail control unit 32. The common rail control unit 32 which receives the control signal adjusts the fuel injection amount to the internal combustion engine 17. That is, in the embodiment, the internal combustion engine 17 is a diesel engine which can be controlled electronically according to a common rail type. The engine controller 30 can generate a target output in the internal combustion engine 17 by controlling the fuel injection amount to the internal combustion engine 17 through the common rail control unit 32. Further, the engine controller 30 can freely set a torque output with respect to the rotation speed of the internal combustion engine 17 at a certain time point. The hybrid controller 23 and the pump controller 33 receive the setting value of the throttle dial 28 from the engine controller 30.

The internal combustion engine 17 includes the rotation speed detection sensor 17n. The rotation speed detection sensor 17n detects the rotation speed of the output shaft 17S of the internal combustion engine 17, that is, the engine speed of the output shaft 17S per unit time. The engine controller 30 and the pump controller 33 acquire the rotation speed of the internal combustion engine 17 detected by the rotation speed detection sensor 17n and use the rotation speed in order to control the operation state of the internal combustion engine 17. In the embodiment, the rotation speed detection sensor 17n may detect the engine speed of the internal combustion engine 17 and the engine controller 30 and the pump controller 33 may convert the engine speed into a rotation speed. In the embodiment, the actual rotation speed of the internal combustion engine 17 can be substituted for a value detected by the rotation sensor 25m of the generator motor 19.

The pump controller 33 controls the flow rate of the hydraulic oil ejected from the hydraulic pump 18. In the embodiment, the pump controller 33 includes a computer including a processor such as a CPU and a memory. The pump controller 33 receives signals transmitted from the engine controller 30 and the lever operation amount detection unit 27. Then, the pump controller 33 generates a control instruction for adjusting the flow rate of the hydraulic oil ejected from the hydraulic pump 18. The pump controller 33 changes the flow rate of the hydraulic oil ejected from the hydraulic pump 18 by changing the swash plate angle of the hydraulic pump 18 using the generated control signal.

A signal is input to the pump controller 33 from a swash plate angle sensor 18a which detects the swash plate angle of the hydraulic pump 18. When the swash plate angle sensor 18a detects the swash plate angle, the pump controller 33 can calculate the pump capacity of the hydraulic pump 18. A pump pressure detector 20a which detects the ejection pressure (hereinafter, appropriately referred to as a pump ejection pressure) of the hydraulic pump 18 is provided inside the control valve 20. The detected pump ejection pressure is converted into an electric signal and is input to the pump controller 33.

The engine controller 30, the pump controller 33, and the hybrid controller 23 are connected to one another by, for example, an in-vehicle LAN (Local Area Network) 35 such as a CAN (Controller Area Network). With such a structure, the engine controller 30, the pump controller 33, and the hybrid controller 23 can exchange information with one another.

In the embodiment, at least the engine controller 30 controls the operation state of the internal combustion engine 17. In this case, the engine controller 30 controls the operation state of the internal combustion engine 17 by using information generated by at least one of the pump controller 33 and the hybrid controller 23. In this way, in the embodiment, at least one of the engine controller 30, the pump controller 33, and the hybrid controller 23 serves as a hybrid work machine control device. That is, at least one of these controllers realizes a hybrid work machine control method according to the embodiment and controls the operation state of the engine 36.

In the embodiment, a monitor 38 is connected to an in-vehicle LAN 35. The monitor 38 includes a display unit 38M and an operation unit 38SW, and the display unit 38M displays information on the state of the excavator 1, for example, the rotation speed of the internal combustion engine 17, the temperature of the cooling water of the internal combustion engine 17, and the voltage across the terminals of the electrical storage device 22. The operation unit 38SW is a mechanism used to switch the operation mode of the excavator 1, input an instruction for the fixed manual regeneration of an exhaust gas treatment device 40 to be described, or display and select various menus.

As the operation mode of the excavator 1, for example, a rotation deceleration mode in which the rotation speed of the internal combustion engine 17 becomes an idling state can be exemplified. In the excavator 1 of the embodiment, an auto-deceleration function is set. The auto-deceleration function is used to improve the fuel efficiency by selecting a rotation deceleration mode when a predetermined condition is established in a working state. Further, the setting of the auto-deceleration function can be appropriately cancelled. The operation mode of the excavator 1 is not limited to the example of the embodiment, and various operation modes also exist. The operation mode of the excavator 1 may be switched by, for example, an operation mode selection switch provided inside the cabin 6 of the excavator 1 illustrated in FIG. 1 other than the operation unit 38SW of the monitor 38.

<Internal Combustion Engine 17 and Exhaust Gas Treatment Device 40>

FIG. 3 is a diagram illustrating an example of the internal combustion engine 17 and the exhaust gas treatment device 40. As illustrated in FIG. 3, the exhaust gas treatment device 40 is a device which purifies an exhaust gas discharged from the internal combustion engine 17 to an exhaust pipe 44. The exhaust gas treatment device 40 reduces, for example, NOx (nitrogen oxides) contained in an exhaust gas. The exhaust gas treatment device 40 includes a particle trapping filter 41 which removes particles such as soot in the exhaust gas of the internal combustion engine 17, a reducing catalyst 42 which reduces NOx in the exhaust gas, a reducing agent supply unit 43 which supplies a reducing agent R to the exhaust pipe 44, and a fuel dozer 45 which supplies fuel to the exhaust pipe 44.

The particle trapping filter 41 includes a diesel oxidization catalyst 41a, a particulate matter removing filter 41b, a temperature sensor 41c, and a differential pressure sensor 41d. The diesel oxidization catalyst 41a and the particulate matter removing filter 41b are provided inside the exhaust pipe 44. The diesel oxidization catalyst 41a is disposed at the upstream side of the exhaust pipe 44 and the particulate matter removing filter 41b is disposed at the downstream side thereof. The diesel oxidization catalyst 41a is realized by, for example, Pt (platinum) or the like and oxidizes and removes CO (carbon monoxide) and HC (hydrocarbon) contained in the exhaust gas and SOF (organic soluble element) contained in the particulate matter.

The particulate matter removing filter 41b traps particulate matter. The particulate matter removing filter 41b is realized based on, for example, silicon carbide. The particulate matter contained in the exhaust gas is trapped while passing through microscopic holes formed in the particulate matter removing filter 41b. The particulate matter removing filter 41b has a configuration in which a cell having a microscopic passage in the exhaust gas flow direction is densely disposed inside a cylindrical exhaust pipe. Then, a wall flow type particulate matter removing filter is realized in which a cell having a sealed upstream end and a cell having a sealed downstream end are alternately disposed. The trapped particulate matter is oxidized (burned) by oxygen contained in the exhaust gas and NO₂ generated by the diesel oxidization catalyst 41a on the condition of the temperature in which the oxidization reaction of the exhaust gas occurs.

When the amount of soot accumulated on the particulate matter removing filter 41b increases, the exhaust gas treatment device 40 increases the temperature of the exhaust gas by burning fuel through the diesel oxidization catalyst 41a disposed at the upstream side. Then, the accumulated particulate matter is burned by the high-temperature exhaust gas so as to regenerate the particulate matter removing filter 41b. The amount of fuel supplied to the diesel oxidization catalyst 41a is set in response to the flow rate of the exhaust gas flowing therethrough. The regeneration includes, for example, an auto-regeneration of automatically burning the particulate matter and a fixed manual regeneration manually performed by the driver of the excavator 1. For example, the auto-regeneration is simply performed even in a state where the excavator 1 performs a work according to the determination of the engine controller 30. The fixed manual regeneration is performed based on the operation of the operator while the excavator 1 is fixed to a stable place and no work is performed. In the fixed manual regeneration, the combustion of the particulate matter in the regeneration operation is more precisely controlled compared with the auto-regeneration, and hence the rotation speed of the internal combustion engine 17 is limited.

An example of an operation in the fixed manual regeneration will be described. For example, a fixed manual regeneration instruction is input to the engine controller 30 by the operation of the operator. When the fixed manual regeneration instruction is input, the engine controller 30 sets the rotation speed of the internal combustion engine 17 to a predetermined limit speed and supplies fuel from the fuel dozer 45 into the exhaust pipe 44. In the particulate matter removing filter 41b, the accumulated particulate matter (soot or the like) is burned by the exhaust gas supplied from the internal combustion engine 17 and the fuel supplied from the fuel dozer 45. The engine controller 30 continuously supplies fuel from the fuel dozer 45 when the value (the particulate matter accumulation amount) of the differential pressure sensor 41d becomes smaller than a predetermined value and stops the supply of fuel when the value becomes smaller than the predetermined value. Accordingly, the fixed manual regeneration is performed until the particulate matter accumulation amount is smaller than the predetermined value. Further, the engine controller 30 sets the engine limit rotation speed during the fixed manual regeneration. When the engine rotation speed exceeds the engine limit rotation speed, the regeneration is stopped based on the determination that the regeneration is not normally performed and the exhaust gas cannot be appropriately and continuously performed after the regeneration.

<Control of Engine 36>

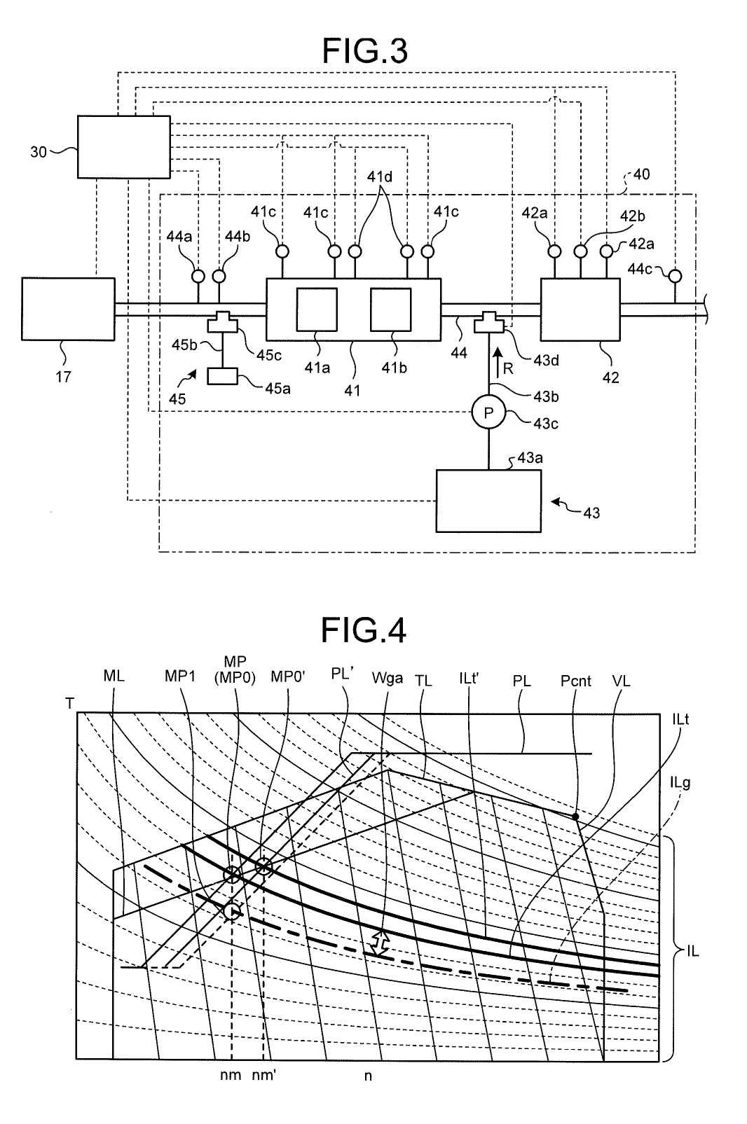

FIG. 4 is a diagram illustrating an example of a torque chart used to control the engine 36 according to the embodiment. The torque chart is used to control the engine 36, that is, the internal combustion engine 17. The torque chart illustrates a relation between the torque T (N×m) of the output shaft 17S of the internal combustion engine 17 and the rotation speed n (rpm: rev/min) of the output shaft 17S. In the embodiment, the rotor 19R of the generator motor 19 is connected to the output shaft 17S of the internal combustion engine 17. For this reason, the rotation speed n of the output shaft 17S of the internal combustion engine 17 has the same relation as the rotation speed of the rotor 19R of the generator motor 19. Hereinafter, it is assumed that the rotation speed n is any one of the rotation speed of the output shaft 17S of the internal combustion engine 17 and the rotation speed of the rotor 19R of the generator motor 19. In the embodiment, the output of the internal combustion engine 17 and the output of the generator motor 19 serving as the motor correspond to horsepower and the unit thereof is a power rate. The output of the generator motor 19 serving as the generator corresponds to electric power and the unit thereof is a power rate.

The torque chart includes a maximum torque line TL, a limit line VL, a pump absorbing torque line PL, a matching route ML, and an output instruction line IL. The maximum torque line TL indicates the maximum output which can be generated by the internal combustion engine 17 during the operation of the excavator 1 illustrated in FIG. 1. The maximum torque line TL indicates a relation between the rotation speed n of the internal combustion engine 17 and the torque T which can be generated by the internal combustion engine 17 at each rotation speed n.

The torque chart is used to control the internal combustion engine 17. In the embodiment, the engine controller 30 stores the torque chart in a storage unit and uses the torque chart to control the internal combustion engine 17. At last one of the hybrid controller 23 and the pump controller 33 may store the torque chart in the storage unit.

The torque T of the internal combustion engine 17 indicated by the maximum torque line TL is determined in consideration of the durability and the exhaust smoke limit of the internal combustion engine 17. For this reason, the internal combustion engine 17 can generate a torque larger than the torque T corresponding to the maximum torque line TL. In fact, the engine control device, for example, the engine controller 30 controls the internal combustion engine 17 so that the torque T of the internal combustion engine 17 does not exceed the maximum torque line TL.

The output, that is, the horsepower generated by the internal combustion engine 17 becomes maximal at an intersection point Pcnt between the limit line VL and the maximum torque line TL. The intersection point Pcnt will be referred to as a rated point. The output of the internal combustion engine 17 at the rated point Pcnt will be referred to as a rated output. The maximum torque line TL is determined from the exhaust smoke limit as described above. The limit line VL is determined based on the maximum rotation speed. Accordingly, the rated output is the maximum output of the internal combustion engine 17 determined based on the exhaust smoke limit and the maximum rotation speed of the internal combustion engine 17.

The limit line VL limits the rotation speed n of the internal combustion engine 17. That is, the rotation speed n of the internal combustion engine 17 is controlled by the engine control device, for example, the engine controller 30 so as not to exceed the limit line VL. The limit line VL defines the maximum rotation speed of the internal combustion engine 17. That is, the engine control device, for example, the engine controller 30 controls the maximum rotation speed of the internal combustion engine 17 so that the maximum rotation speed does not exceed the rotation speed defined by the limit line VL.

The pump absorbing torque line PL indicates the maximum torque (the pump absorbing torque instruction value) which can be absorbed by the hydraulic pump 18 illustrated in FIG. 2 at the rotation speed n of the internal combustion engine 17. In the internal combustion engine 17 according to the embodiment, the output of the internal combustion engine 17 and the load of the hydraulic pump 18 are adjusted in balance along the matching route ML.

For example, the matching route ML is set so that the torque of the internal combustion engine 17 increases in accordance with an increase in the output of the internal combustion engine 17 and intersects the maximum torque line TL. At this time, the matching route ML is set so that the rotation speed at the intersection point with respect to the maximum torque line TL becomes a rotation speed higher than the maximum torque rotation speed defined by the maximum torque line TL.

The output instruction line IL indicates the target values of the rotation speed n and the torque T of the internal combustion engine 17. That is, the internal combustion engine 17 is controlled so as to obtain the rotation speed n and the torque T obtained from the output instruction line IL. In this way, the output instruction line IL is used to define the value of the power generated by the internal combustion engine 17. The output instruction line IL has an instruction value (hereinafter, appropriately referred to as an output instruction value) of the horsepower, that is, the output generated by the internal combustion engine 17. That is, the engine control device, for example, the engine controller 30 controls the torque T and the rotation speed n of the internal combustion engine 17 so as to have the torque T and the rotation speed n on the output instruction line IL corresponding to the output instruction value. For example, when the output instruction line ILt corresponds to the output instruction value, the torque T and the rotation speed n of the internal combustion engine 17 are controlled so as to have values on the output instruction line ILt.

The torque chart includes the output instruction lines IL. A value between the adjacent output instruction lines IL can be obtained by, for example, an interpolation. In the embodiment, the output instruction line IL is an iso-horsepower line. The iso-horsepower line sets a relation between the torque T and the rotation speed n so that the output of the internal combustion engine 17 becomes uniform. In the embodiment, the output instruction line IL is not limited to the iso-horsepower line, but may be an arbitrary line such as an iso-throttle line.

In the embodiment, the internal combustion engine 17 is controlled at the torque T and the rotation speed nm of the matching point MP. The matching point MP indicates an intersection point of the matching route ML indicated by the solid line of FIG. 4, the output instruction line ILt indicated by the solid line of FIG. 4, and the pump absorbing torque line PL. The matching point MP indicates a balance point between the output of the internal combustion engine 17 and the load of the hydraulic pump 18. The output instruction line ILt indicated by the solid line corresponds to the target output of the internal combustion engine 17 and the target output of the internal combustion engine 17 absorbed by the hydraulic pump 18 at the matching point MP.

When the generator motor 19 generates power, an instruction is given to the pump controller 33 and the hybrid controller 23 so that the output of the internal combustion engine 17 absorbed by the hydraulic pump 18 decreases by the horsepower, that is, the generation output Wga absorbed by the generator motor 19. The pump absorbing torque line PL moves to a position indicated by the dotted line. The output instruction line ILg corresponds to the output at this time. The absorbing torque line PL absorbed by the pump and the generator intersects the output instruction line ILg at the rotation speed nm of the matching point MP1. The output instruction line ILt passing through the matching point MP0 is obtained by adding the generation output Wga absorbed by the generator motor 19 to the output instruction line ILg.

In the embodiment, an example is illustrated in which the output of the internal combustion engine 17 and the load of the hydraulic pump 18 are balanced at the matching point MP0 as the intersection point of the matching route ML, the output instruction line ILt, and the pump absorbing torque line PL. Further, when the generation output Wga increases, the matching route ML moves from the matching point MP0 to MP0′, the output instruction line moves from ILt to ILt′, and the absorbing torque line moves from PL to PL′. At this time, the engine rotation speed moves from nm to nm′.

In this way, the engine 36, that is, the internal combustion engine 17 and the generator motor 19 are controlled based on the maximum torque line TL, the limit line VL, the pump absorbing torque line PL, the matching route ML, and the output instruction line IL included in the torque chart.

<Configuration Example of Hybrid Controller 23>

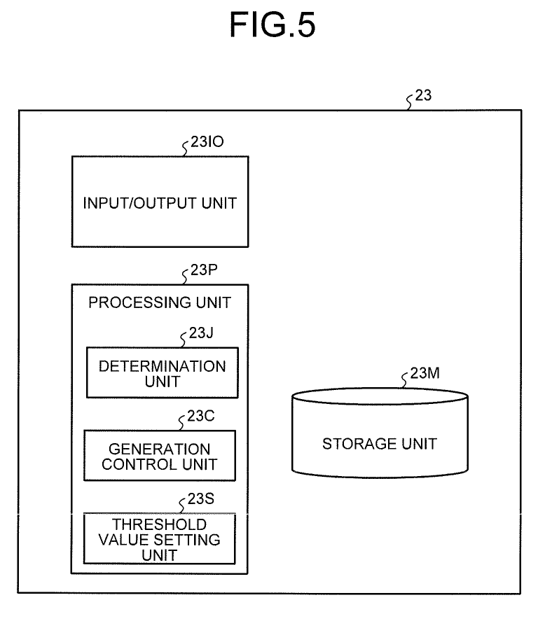

FIG. 5 is a diagram illustrating a configuration example of the hybrid controller 23. The hybrid controller 23 includes a processing unit 23P, a storage unit 23M, and an input/output unit 2310. The processing unit 23P is a CPU (Central Processing Unit), a microprocessor, or a microcomputer. Hereinafter, in order to describe the control of respective units, for example, the control of the hybrid controller 23 will be exemplified. However, control based on the other controller may be performed or control based on a plurality of controllers may be performed.

The processing unit 23P includes a determination unit 23J, a generation control unit 23C, and a threshold value setting unit 23S. The processing unit 23P of the hybrid controller 23, that is, the determination unit 23J, the generation control unit 23C, and the threshold value setting unit 23S perform a hybrid work machine control method according to the embodiment. The determination unit 23J determines whether the excavator 1 is in a fixed manual regeneration mode.

For example, when the operator inputs an instruction for performing the fixed manual regeneration of the exhaust gas treatment device 40 to the monitor 38, the particle accumulation amount in the particle trapping filter 41 is equal to or larger than a predetermined amount, the rotation speed instruction value of the internal combustion engine 17 is smaller than a predetermined value, the rotation speed of the internal combustion engine 17 falls within a predetermined rotation speed so as not to be different from the rotation speed instruction value, and the excavator 1 is in a vehicle safety state in which a pilot hydraulic pressure locking lever operating the working implement is prohibited while a pilot hydraulic pressure generated by the operation of the lever is interrupted, the determination unit 23J determines that the current mode is the fixed manual regeneration mode. When the determination unit 23J determines that the current mode is the fixed manual regeneration mode, the determination unit outputs a regeneration state valid flag. Further, when the determination unit 23J determines that the current mode is not the fixed manual regeneration mode, the determination unit outputs a regeneration state invalid flag.

The generation control unit 23C controls the generation of the generator motor 19 so that the actual capacitance value of the electrical storage device 22 is not smaller than a predetermined target voltage value. In the embodiment, the capacitance indicates the electric amount stored in the electrical storage device 22. For example, when a capacitance value decreases to a charging request voltage value (Vm) due to the self-discharging of the electrical storage device 22, the generation control unit 23C generates power by the generator motor 19 so as to return the capacitance value to a target capacitance value (V0). In the embodiment, the charging request voltage value is a threshold value in which the charging of the electrical storage device 22 is started. Further, the target capacitance value is a threshold value in which the charging of the electrical storage device 22 is completed. The target capacitance value is set to, for example, the rated capacitance value of the electrical storage device 22. Further, the target capacitance value may be set to, for example, the capacitance value having highest generation efficiency. Further, in order to suppress degradation in generation efficiency, the generation control unit 23C does not generate power when the generation torque is not equal to or higher than a predetermined value (a lower-limit setting value). In the embodiment, the lower-limit setting value is marked as the minimum generation torque.

When the determination unit 23J determines that the current mode is the fixed manual mode, the threshold value setting unit 23S sets the threshold value in which the generation of the generator motor 19 is started to the minimum generation torque as the lower limit value. Further, when the determination unit 23J determines that the current mode is not the fixed manual mode, the threshold value setting unit 23S sets the threshold value to the generation torque based on the charging request.

When the processing unit 23P is dedicated hardware, for example, one or a combination of various circuits, a programmed processor, and an ASIC (Application Specific Integrated Circuit) corresponds to the processing unit 23P.

As the storage unit 23M, for example, at least one of various non-volatile or volatile memories such as RAM (Random Access Memory) and ROM (Read Only Memory) and various disks such as a magnetic disk is used. The storage unit 23M stores a computer program causing the processing unit 23P to control the hybrid work machine according to the embodiment and information used to perform control according to the embodiment by the processing unit 23P. The processing unit 23P realizes control according to the embodiment by reading the computer program from the storage unit 23M.

The input/output unit 2310 is an interface circuit used to connect the engine controller 30 and electronic units to each other. The fuel adjustment dial 28, the rotation speed detection sensor 17n, and the common rail control unit 32 illustrated in FIG. 2 are connected to the input/output unit 2310. Further, various sensors including the temperature sensor 41c, the differential pressure sensor 41d, a temperature sensor 42a, an ammonia sensor 42b, a NOx detection sensor 44a, and a pressure sensor 44b illustrated in FIG. 3 are connected to the input/output unit 2310. In the embodiment, the configuration example of the engine controller 30 has been described, but the hybrid controller 23 and the pump controller 33 also have the same configuration as the engine controller 30. In the embodiment, each of the hybrid controller 23 and the engine controller 30 is a control device for a hybrid machine. In the embodiment, the engine controller 30 is the engine control unit.

<Control Block of Hybrid Controller 23>

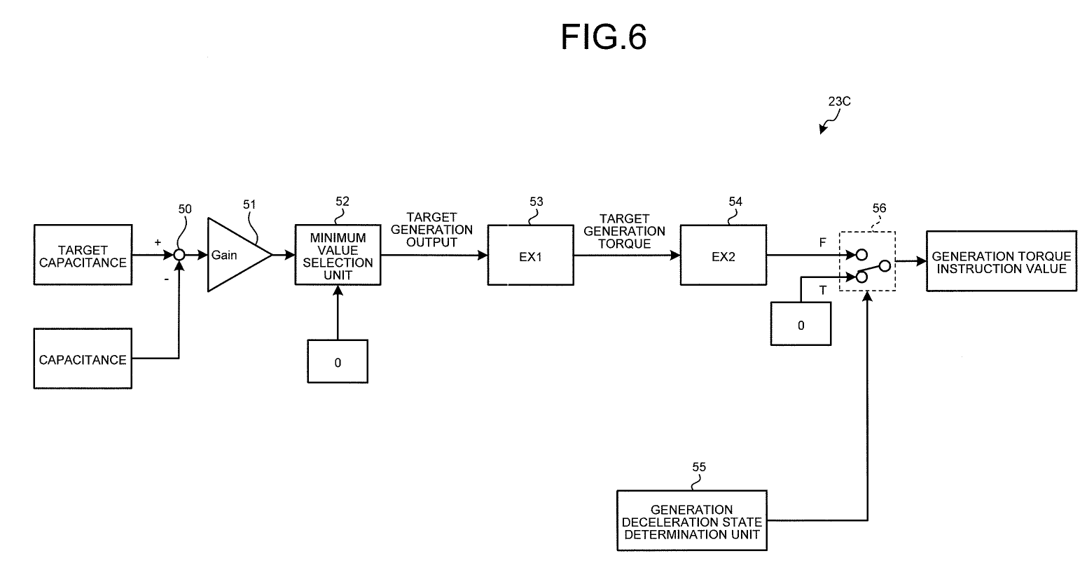

FIG. 6 is a control block diagram of the generation control unit 23C of the hybrid controller 23. The generation control unit 23C includes an addition/subtraction unit 50, a gain 51, a minimum value selection unit 52, a target generation torque calculation unit 53, an instruction value calculation unit 54, a generation deceleration state determination unit 55, and a selection unit 56.

The target capacitance value (V0) and the capacitance value of the electrical storage device 22 are input to the addition/subtraction unit 50. The addition/subtraction unit 50 subtracts the capacitance value from the target capacitance value and outputs a calculation result. The calculation result of the addition/subtraction unit 50 is input to the gain 51. The gain 51 multiplies the calculation result as the input value by a coefficient (which has a unit of kW/V and a negative value) and outputs a result. Since the output value of the gain 51 is obtained by multiplying the target capacitance value by a negative value, a negative value is obtained in principle.

The value of 0 (V) and the calculation result of the addition/subtraction unit 50 are input to the minimum value selection unit 52. The minimum value selection unit 52 compares the calculation result and 0 (V) and outputs a small value as the target generation output value.

The output result of the minimum value selection unit 52 is input to the target generation torque calculation unit 53. The target generation torque calculation unit 53 calculates the target generation torque based on the rotation speed n and the input target generation output value. Specifically, the target generation torque calculation unit 53 divides the target generation output value by the rotation speed of the generator motor and divides a value obtained by multiplying the result by 60 and 1000 by 2π. The target generation torque calculation unit 53 outputs the calculation result as the target generation torque.

The target generation torque as the calculation result of the target generation torque calculation unit 53 is input to the instruction value calculation unit 54. The instruction value calculation unit 54 calculates the generation torque instruction value based on the target generation torque and outputs the generation torque instruction value. The instruction value calculation unit 54 outputs 0 (Nm) when the target generation torque is a predetermined value smaller than the minimum generation torque, and outputs the value of the target generation torque equal to the input value when the target generation torque is equal to or larger than the minimum generation torque.

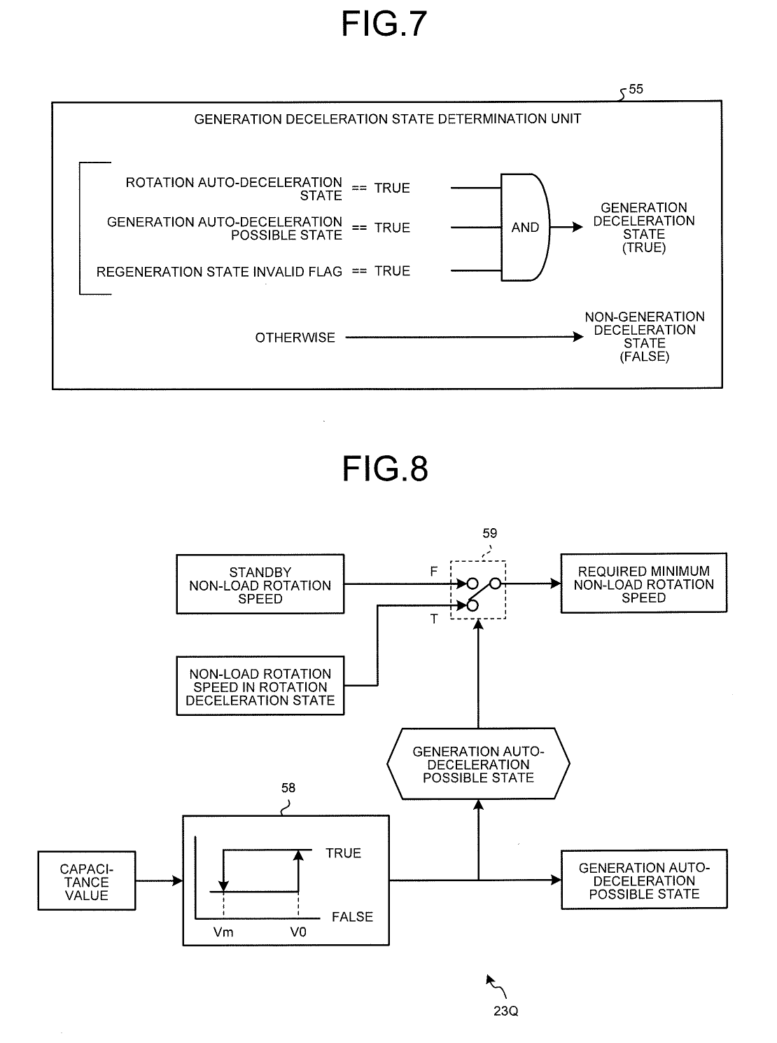

The generation deceleration state determination unit 55 determines whether the hybrid controller 23 is in the generation deceleration state (TRUE) or not (FALSE) and outputs a determination result. FIG. 7 is a diagram illustrating an example of the calculation block of the generation deceleration state determination unit 55. As illustrated in FIG. 7, for example, the generation deceleration state determination unit 55 determines that the current state is the generation deceleration state (TRUE), for example, when the current state is the rotation auto-deceleration state and the generation auto-deceleration possible state and the regeneration state invalid flag is output in the determination unit 23J. The generation deceleration state determination unit 55 determines that the current state is not the generation deceleration state (FALSE) in other cases.

The determination on the rotation auto-deceleration state is performed by, for example, the processing unit 23P of the hybrid controller 23 separately from the process of the generation control unit 23C. For example, when the auto-deceleration function is set in the monitor 38, the throttle value is equal to or smaller than a predetermined value, and a predetermined time elapses while all levers including the operation levers 26R, 26L are in a neutral state, the processing unit 23P determines that the current state is the rotation auto-deceleration state. In addition, the throttle value in the determination of the rotation auto-deceleration state may not be used as the determination reference.

The determination on the generation auto-deceleration possible state is performed by, for example, the processing unit 23P of the hybrid controller 23 separately from the process of the generation control unit 23C. FIG. 8 is a diagram illustrating an example of a calculation block 23Q of the processing unit 23P. As illustrated in FIG. 8, the calculation block 23Q includes a generation auto-deceleration possible state determination unit 58 and a selection unit 59. The capacitance value of the electrical storage device 22 is input to the generation auto-deceleration possible state determination unit 58. The generation auto-deceleration possible state determination unit 58 determines that the current state is the generation auto-deceleration possible state (TRUE) when the input capacitance value is larger than the charging request voltage value (V0). The generation auto-deceleration possible state determination unit 58 determines that the current state is the generation auto-deceleration possible state (FALSE) when the input capacitance value is equal to or smaller than the charging request voltage value (Vm). Further, the non-load rotation speed value (FALSE) of the internal combustion engine 17 in the standby state and the non-load rotation speed value (TRUE) of the internal combustion engine 17 in the rotation deceleration state are input to the selection unit 59. The non-load rotation speed values of the internal combustion engine 17 in the standby state and the rotation deceleration state are predetermined values and are stored in, for example, the storage unit 23M. The selection unit 59 outputs the non-load rotation speed of the internal combustion engine 17 in the rotation deceleration stat when the determination result of the generation auto-deceleration possible state determination unit 58 is TRUE. The selection unit 59 outputs the non-load rotation speed of the internal combustion engine 17 in the standby state as the required minimum non-load rotation speed when the determination result of the generation auto-deceleration possible state determination unit 58 is FALSE. Further, the non-load rotation speed of the internal combustion engine 17 in the standby state is set so as to become higher than the non-load rotation speed of the internal combustion engine 17 in the rotation deceleration state. The non-load rotation speed of the internal combustion engine 17 in the standby state is determined as the rotation speed of the internal combustion engine 17 for the regeneration. Accordingly, when the non-load rotation speed of the internal combustion engine 17 in the rotation deceleration state is set to be low, the fuel consumption of the working implement in the standby state can be suppressed to be low.

Returning to FIG. 6, the value of 0 (Nm) and the generation torque instruction value as the calculation result of the instruction value calculation unit 54 are input to the selection unit 56. Based on the determination result of the generation deceleration state determination unit 55, the selection unit 56 selects any one of two input values and outputs the selected value. Specifically, the selection unit 56 outputs the generation torque instruction value as the calculation result of the instruction value calculation unit 54 when the determination result of the generation deceleration state determination unit 55 is TRUE. Further, the selection unit 56 outputs the value of 0 (Nm) as the generation torque instruction value when the determination result of the generation deceleration state determination unit 55 is FALSE.

Accordingly, for example, when a voltage drop occurs in the electrical storage device 22 so that the capacitance value reaches the charging request voltage value in a case where the current mode is not the fixed regeneration mode, the current state is not the generation auto-deceleration possible state. For this reason, the output of the generation deceleration state determination unit 55 indicates a state where the current state is not the generation deceleration state (FALSE). In this case, the output value of the selection unit 56 becomes the output of the instruction value calculation unit 54. The instruction value calculation unit 54 outputs the target generation torque corresponding to the charging request voltage value. Since the output value becomes the generation torque instruction value, the generator motor 19 generates power at the target generation torque corresponding to the charging request voltage value. When power is generated by the generator motor 19, the capacitance of the electrical storage device 22 reaches the target capacitance. Accordingly, the output of the generation auto-deceleration possible state determination unit 58 returns to the generation auto-deceleration possible state. Accordingly, the output of the generation deceleration state determination unit 55 becomes the generation deceleration state (TRUE) and hence the generation torque instruction value becomes zero. In this way, when the current mode is not the fixed regeneration mode, the generator motor 19 is charged whenever the capacitance value reaches the charging request voltage value.

Further, in the fixed manual regeneration mode, the regeneration state valid flag is output to the determination unit 23J instead of the regeneration state invalid flag. For this reason, the output of the generation deceleration state determination unit 55 indicates a state where the current state is not the generation deceleration state (FALSE). In this case, the output value of the selection unit 56 becomes the output of the instruction value calculation unit 54. The instruction value calculation unit 54 outputs the minimum generation torque when the target generation torque reaches the minimum generation torque. Since the output value becomes the generation torque instruction value, the generator motor 19 generates power at the minimum generation torque. When power is generated by the generator motor 19, the capacitance of the electrical storage device 22 reaches the target capacitance. However, in the fixed manual regeneration mode, the regeneration state invalid flag is not output even when the capacitance reaches the target capacitance. For this reason, the current state is not the generation deceleration state. For this reason, for example, when a voltage drop occurs in the electrical storage device 22, the generator motor 19 generates power whenever the target generation torque reaches the minimum generation torque. In this way, in the fixed manual regeneration mode, the generator motor 19 generates power by using the threshold value in which the target generation torque reaches the minimum generation torque. Accordingly, the generator motor 19 generates power regardless of the state where the capacitance value of the electrical storage device 22 reaches the charging request voltage value.

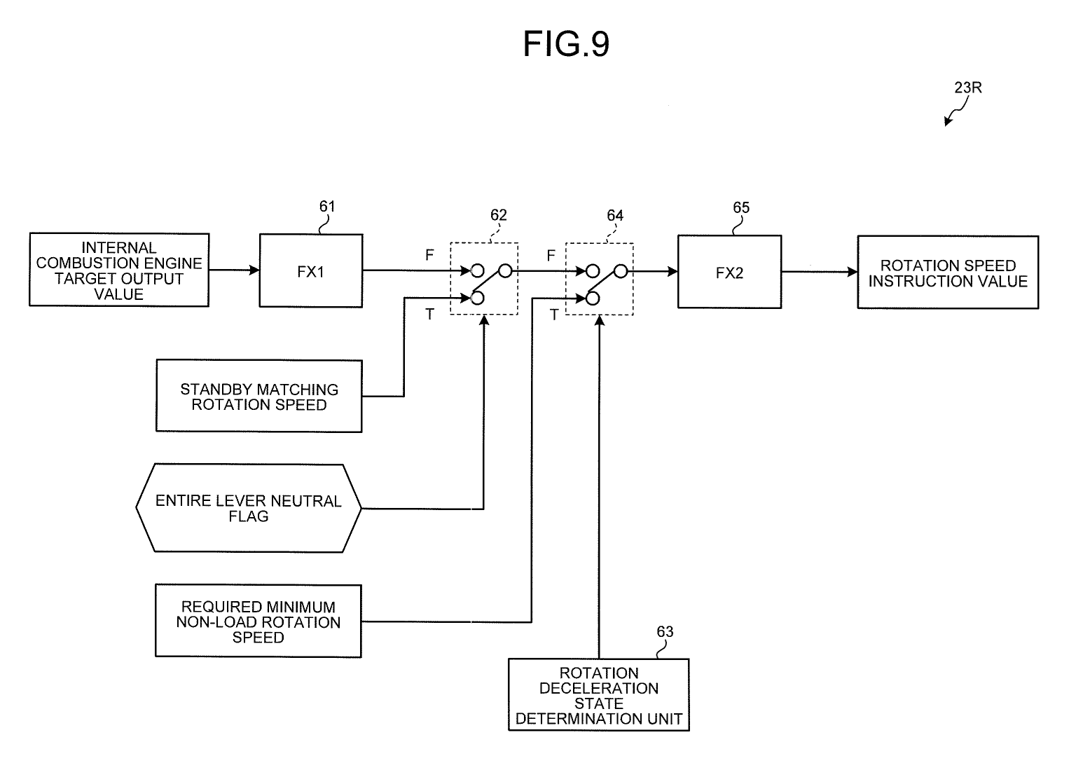

Further, the processing unit 23P calculates the rotation speed instruction value of the internal combustion engine 17. FIG. 9 is a diagram illustrating an example of a calculation block 23R of the processing unit 23P. The calculation block 23R outputs the rotation speed instruction value. The calculation block 23R includes a matching maximum rotation speed calculation unit 61, a first selection unit 62, a rotation deceleration state determination unit 63, a second selection unit 64, and a rotation speed instruction value calculation unit 65.

The target output value of the internal combustion engine 17 is input to the matching maximum rotation speed calculation unit 61. The target output value is set as the target value corresponding to the working implement load state determined based on the operation of the levers of the operation levers 26R, 26L of the working implement 3, the pressure of the hydraulic pump 18, and the target generation output of the generator motor 19. The matching maximum rotation speed calculation unit 61 calculates the matching maximum rotation speed based on the input target output value of the internal combustion engine 17 and given information such as data map having a predetermined relation with respect to the target output value of the internal combustion engine 17 and outputs the matching maximum rotation speed.

The matching maximum rotation speed as the output value of the matching maximum rotation speed calculation unit 61 and the matching rotation speed (the standby matching rotation speed) of the internal combustion engine 17 in the standby state of the excavator 1 are input to the first selection unit 62. The first selection unit 62 outputs the matching maximum rotation speed when the entire lever neutral flag is TRUE, that is, all levers of the excavator 1 are in the neutral state. Further, the first selection unit 62 outputs the standby matching rotation speed when the entire lever neutral flag is FALSE.

The rotation deceleration state determination unit 63 determines whether the current state is the rotation deceleration state (TRUE) or not (FALSE). The determination on the rotation deceleration state is performed similarly to the determination of the processing unit 23P of the hybrid controller 23. Further, the determination result of the processing unit 23P may be used as the determination result of a rotation deceleration state determination unit 66.

The output value (the matching maximum rotation speed or the standby matching rotation speed) of the first selection unit 62 and the required minimum non-load rotation speed as the output value of the selection unit 59 of the calculation block 23Q are input to the second selection unit 64. The second selection unit 64 outputs the required minimum non-load rotation speed when the determination result of the rotation deceleration state determination unit 63 is TRUE, that is, the current state is the rotation deceleration state. Further, the second selection unit 64 outputs the output value of the first selection unit 62 when the determination result of the rotation deceleration state determination unit 63 is FALSE.

The output value of the second selection unit 64 is input to the rotation speed instruction value calculation unit 65. The rotation speed instruction value calculation unit 65 calculates the rotation speed instruction value based on the output value of the second selection unit 64 and outputs the rotation speed instruction value. In this way, in the embodiment, the calculation block 23R is a rotation speed control unit that controls the rotation of the internal combustion engine 17 based on the load of the working implement 3.

<Hybrid Work machine Control Method>

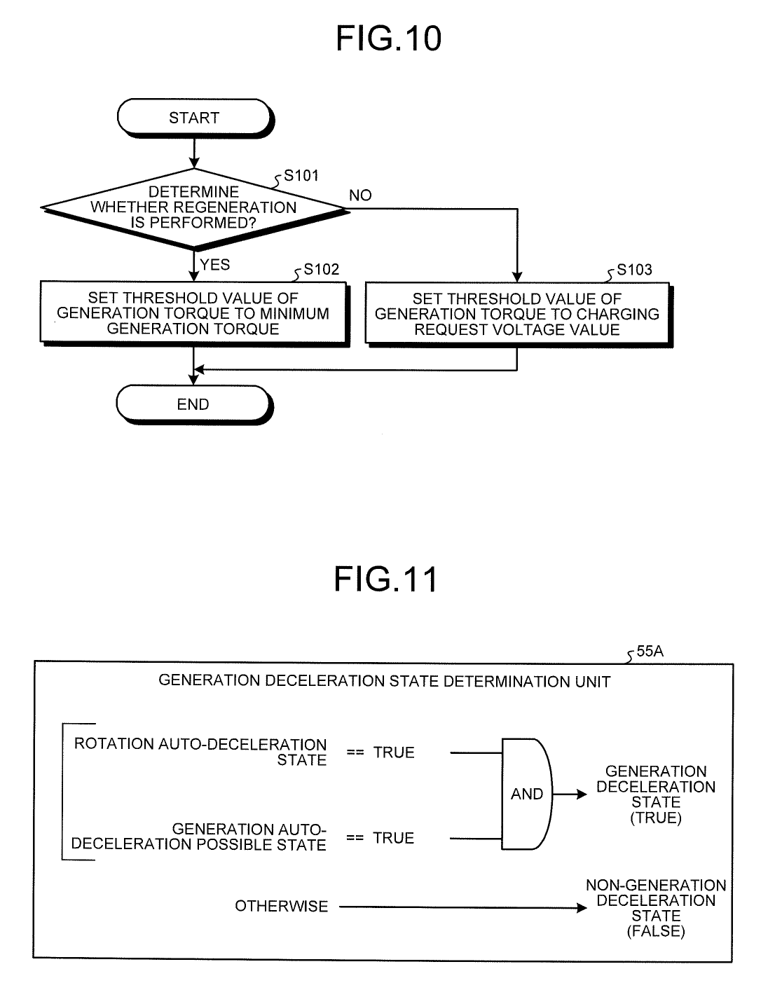

FIG. 10 is a flowchart illustrating an example of the hybrid work machine control method according to the embodiment. In step S101, the determination unit 23J of the hybrid controller 23 determines whether the current mode is the fixed manual regeneration mode. When the current mode is the fixed manual regeneration mode (Yes in step S101), the threshold value setting unit 23S sets the generation torque instruction value as the threshold value in which the generation of the generator motor 19 is started to the minimum generation torque in step S102. Further, when the current mode is not the fixed manual regeneration mode (No in step S101), the threshold value setting unit 23S sets the generation torque instruction value as the threshold value in which the generation of the generator motor 19 is started to the output value of the target generation torque calculation unit 53 when the capacitance value based on the charging request is V0 in step S103.

As described above, since the threshold value in which the generation of the generator motor 19 is started is set to the minimum generation torque as the lower limit value, the excavator 1 according to the embodiment suppresses the high-torque generation when the generator motor 19 generates power in the fixed manual regeneration mode. Accordingly, it is possible to suppress a change in the rotation speed of the internal combustion engine 17 in the fixed manual regeneration mode. Accordingly, since it is possible to decrease a possibility that the rotation speed of the internal combustion engine 17 is different from the rotation speed instruction value from the fixed manual regeneration start condition, it is possible to suppress the interruption of the fixed manual regeneration.

<Modified Example of Hybrid Controller 23>

In the above-described embodiment, a case has been exemplified in which the hybrid controller 23 sets the threshold value in which the generation is started to the minimum generation torque in the fixed manual regeneration mode, but the invention is not limited thereto. For example, the hybrid controller 23 may separately change the charging request voltage value in the fixed manual regeneration mode and the non-fixed manual regeneration mode. Specifically, when the current mode is not the fixed manual regeneration mode, the threshold value setting unit 23S of the hybrid controller 23 may set the charging request voltage value of the electrical storage device 20 to a predetermined first voltage value. Meanwhile, when the current mode is the fixed manual regeneration mode, the threshold value setting unit may set the charging request voltage value to a second voltage value higher than the first voltage value.

The first voltage value may be set to, for example, the charging request voltage value in the rotation speed deceleration state. Since the electric power of the electrical storage device 20 is not easily needed in the rotation speed deceleration state, there is a low possibility of a problem even when the capacitance value of a charging device 20 decreases. For this reason, since the hybrid controller 23 sets the charging request voltage value to a low value so as to suppress the generation of the generator motor 19 in the internal combustion engine 17, the fuel consumption is suppressed. Accordingly, since the charging request voltage value is set to the charging request voltage value in the rotation deceleration state when the current mode is not the fixed manual regeneration mode, the fuel consumption can be suppressed.

For example, the second voltage value may be set to the voltage value in which the target generation torque of the generator motor 19 becomes the minimum generation torque. Further, the second voltage value may be a value larger than the first voltage value or the other values. For example, the second voltage value may be a voltage value between the first voltage value and the voltage value in which the target generation torque of the generator motor 19 becomes the minimum generation torque.

FIG. 11 is a diagram illustrating a calculation block of a generation deceleration state determination unit 55A of the generation control unit 23C in the hybrid controller 23 according to a modified example. As illustrated in FIG. 11, the generation deceleration state determination unit 55A determines that the current state is the generation deceleration state (TRUE), for example, when the current state is the rotation auto-deceleration state and the generation auto-deceleration possible state. The generation deceleration state determination unit 55A determines that the current state is not the generation deceleration state (FALSE) in other cases.

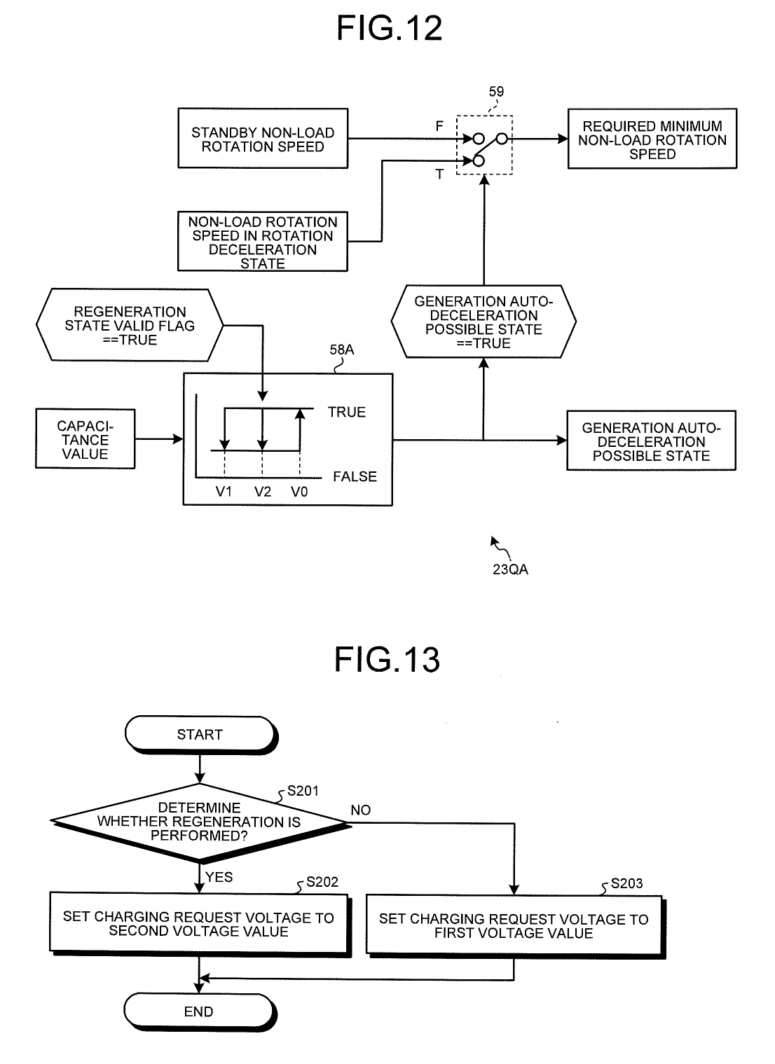

FIG. 12 is a diagram illustrating an example of a calculation block 23QA according to the modified example. The calculation block 23QA is a calculation block determining whether the current state is the generation auto-deceleration possible state. The calculation block 23QA includes a generation auto-deceleration possible state determination unit 58A and the selection unit 59. The capacitance value of the electrical storage device 22 and the regeneration state valid flag are input to the generation auto-deceleration possible state determination unit 58A.

In the generation auto-deceleration possible state determination unit 58A, since the regeneration state valid flag is not input (FALSE) when the current mode is not the fixed regeneration mode, the threshold value setting unit 23S sets the charging request voltage value to the first voltage value V1. In this case, the generation auto-deceleration possible state determination unit 58A determines whether the current state is the generation auto-deceleration possible state (TRUE) when the input capacitance value is larger than the first voltage value V1 as the charging request voltage value. The generation auto-deceleration possible state determination unit 58A determines that the current state is not the generation auto-deceleration possible state (FALSE) when the input capacitance value is equal to or smaller than the first voltage value V1.

Further, in the generation auto-deceleration possible state determination unit 58A, since the regeneration state valid flag is input (TRUE) in the fixed regeneration mode, the threshold value setting unit 23S sets the charging request voltage value to the second voltage value V2. In this case, the generation auto-deceleration possible state determination unit 58A determines that the current state is the generation auto-deceleration possible state (TRUE) when the input capacitance value is larger than the second voltage value V2 as the charging request voltage value. The generation auto-deceleration possible state determination unit 58 determines that the current state is not the generation auto-deceleration possible state (FALSE) when the input capacitance value is equal to or smaller than the second voltage value V2. Further, since the configuration of the selection unit 59 is similar to that of the embodiment, the description thereof will be omitted.

Accordingly, for example, when a voltage drop occurs in the electrical storage device 22 so that the capacitance value reaches the charging request voltage value (V1 or V2), the current state is not the generation auto-deceleration possible state. For this reason, the output of the generation deceleration state determination unit 55A indicates a state where the current state is not the generation deceleration state (FALSE). In the modified example, the charging request voltage value is set to the first voltage value V1 when the current mode is not the fixed manual regeneration mode. Meanwhile, the charging request voltage value is set to the second voltage value V2 when the current mode is the fixed manual regeneration mode.

In this case, the output value of the selection unit 56 illustrated in FIG. 6 becomes the output of the instruction value calculation unit 54. The instruction value calculation unit 54 outputs the target generation torque corresponding to the charging request voltage value. Since the output value becomes the generation torque instruction value, the generator motor 19 generates power at the target generation torque corresponding to the charging request voltage value. That is, when the current mode is not the fixed manual regeneration mode, power is generated by a difference between the target voltage value V0 and the first voltage value V1. Further, in the fixed manual regeneration mode, power is generated by a difference between the target voltage value V0 and the second voltage value V2.

When power is generated by the generator motor 19, the capacitance of the electrical storage device 22 reaches the target capacitance and hence the target generation torque returns to zero. Accordingly, the output of the generation auto-deceleration possible state determination unit 58 returns to the generation auto-deceleration possible state. Accordingly, the output of the generation deceleration state determination unit 55 becomes the generation deceleration state (TRUE) so that the generation torque instruction value becomes zero. In this way, in the modified example, the charging is performed by the generator motor 19 when the capacitance value of the electrical storage device 22 reaches the charging request voltage value regardless of the fixed manual regeneration mode. Further, the generation start timing of the generator motor 19 is adjusted by switching the charging request voltage value to the first voltage value V1 or the second voltage value V2 in response to the fixed manual regeneration mode.

FIG. 13 is a flowchart illustrating an example of a hybrid work machine control method according to the modified example. In step S201, the determination unit 23J of the hybrid controller 23 determines whether the current mode is the fixed manual regeneration mode. When the current mode is the fixed manual regeneration mode (Yes in step S201), the threshold value setting unit 23S sets the charging request voltage as the threshold value in which the generation of the generator motor 19 is started to the second voltage value V2 in step S202. Further, when the current mode is not the fixed manual regeneration mode (No in step S201), the threshold value setting unit 23S sets the charging request voltage to the first voltage value V1 in step S203.

As described above, since the excavator 1 according to the modified example sets the threshold value in which the generation of the generator motor 19 is started to the second voltage value V2 larger than the first voltage value V1 in the fixed manual regeneration mode, it is possible to suppress the high-torque generation when power is generated by the generator motor 19. Accordingly, it is possible to suppress a change in the rotation speed of the internal combustion engine 17 in the fixed manual regeneration mode.

<Change in Capacitance and Generation Torque with Time in Rotation Deceleration Mode and Fixed Manual Regeneration Mode>

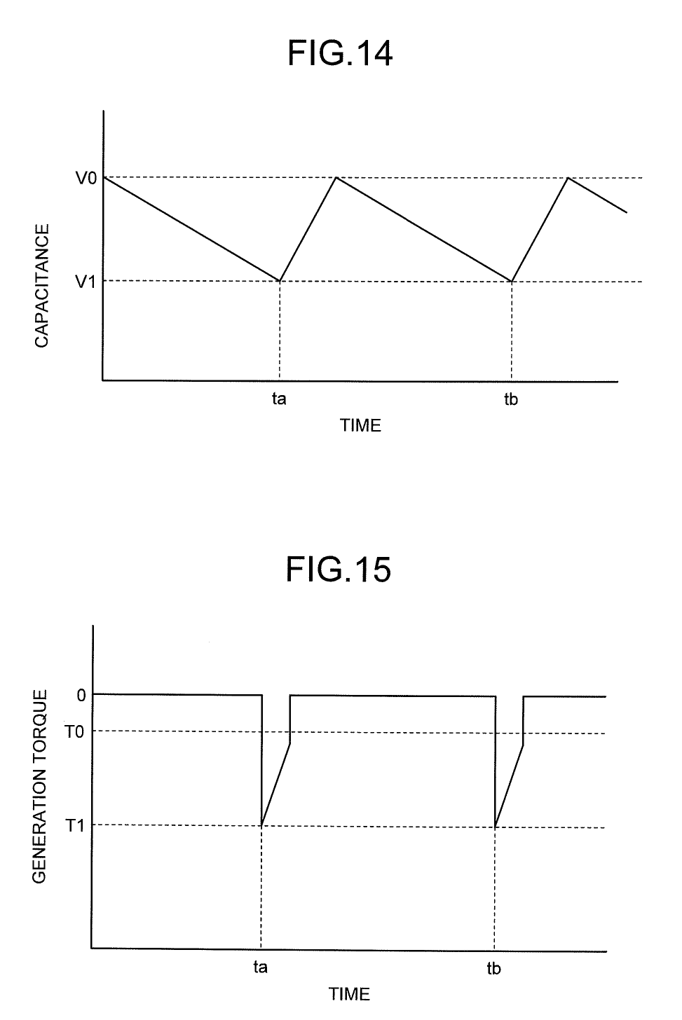

FIG. 14 is a diagram illustrating a change in the capacitance with time in the rotation deceleration mode. In FIG. 14, the vertical axis indicates the capacitance value (V) and the horizontal axis indicates the time. FIG. 15 is a diagram illustrating a change in the generation torque with time in the rotation deceleration mode. In FIG. 15, the vertical axis indicates the generation torque value (Nm) and the horizontal axis indicates the time.

A comparison example will be described in which the standby non-load rotation speed according to the embodiment or the modified example is not performed. In the rotation deceleration mode, as illustrated in FIG. 14, at the time to and the time tb in which the capacitance decreases from the initial voltage V0 to the first voltage value V1 due to the self-discharging, power is generated by the generator motor 19 so as to return the capacitance to the original voltage V0. Since no work is performed in the rotation deceleration mode, a problem hardly occurs even when a change in capacitance increases. Accordingly, since the fuel consumption is more important in the rotation deceleration mode, control is performed so that the generation amount of the generator motor 19 is extremely small.

Further, in the rotation deceleration mode, the generation torque becomes T1 as illustrated in FIG. 15 at the time to and tb in which power is generated by the generator motor 19. The absolute value |T1| of the generation torque T1 is larger than the absolute value |T0| of the minimum generation torque T0 as the lower limit value of the torque necessary to generate power.

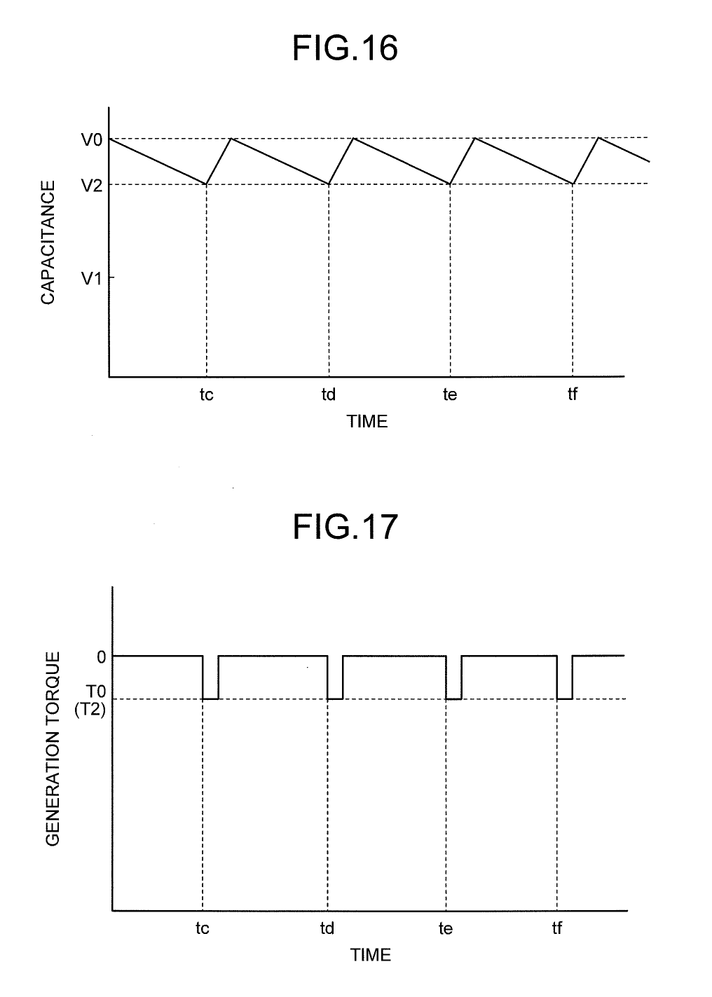

Meanwhile, FIGS. 16 and 17 illustrate an example in which control according to the embodiment or the modified example is performed. FIG. 16 is a diagram illustrating a change in capacitance with time in the fixed manual regeneration mode. In FIG. 16, the vertical axis indicates the capacitance value (V) and the horizontal axis indicates the time. FIG. 17 is a diagram illustrating a change in generation torque with time in the fixed manual regeneration mode. In FIG. 17, the vertical axis indicates the generation torque value (Nm) and the horizontal axis indicates the time.

In the above-described embodiment, when power is generated at the minimum generation torque T0 as illustrated in FIG. 16 in the fixed manual regeneration mode, power is generated by the generator motor 19 at the times tc, td, te, and tf so that the capacitance returns to the initial voltage V0. In this case, the number of times of generating power increases, but an increase in the rotation speed of the internal combustion engine 17 on the matching route can be suppressed. From this result, even in the hybrid construction machine like the excavator 1 that controls the rotation of the internal combustion engine 17, the regeneration can be performed so that the rotation speed of the internal combustion engine 17 does not exceed the upper-limit rotation speed in the fixed manual regeneration mode.

Further, as illustrated in FIG. 16, the capacitance value that starts the generation of power in the embodiment is substantially the second voltage value V2. The second voltage value V2 is a value larger than the first voltage value V1. Accordingly, in the modified example, the same effect as the embodiment can be obtained by setting the threshold value that starts the generation of power to the second voltage value V2 instead of setting the minimum generation torque T0.

For example, the generation torque becomes T2 as illustrated in FIG. 17 at each of the times tc, td, te, and tf of the second voltage value V2. The absolute value |T2| of the generation torque T2 is equal to the absolute value |T0| of the minimum generation torque T0 as the lower limit value of the torque necessary to generate power. For this reason, power is generated at the lowest generation torque in the fixed manual regeneration mode. Accordingly, since the high-torque generation is suppressed, a change in the rotation speed of the internal combustion engine 17 is suppressed.

As described above, the excavator 1 according to the embodiment and the modified example suppresses the high-torque generation when power is generated by the generator motor 19 in the fixed manual regeneration mode. Accordingly, it is possible to suppress a change in the rotation speed of the internal combustion engine 17 in the fixed manual regeneration mode.

In the embodiment, the excavator 1 including the internal combustion engine 17 has been described as the work machine, but the work machine according to the embodiment is not limited thereto. For example, the work machine may be a bulldozer or the like. The type of the engine mounted on the work machine is not also limited. Further, the control according to the embodiment and the modified example is performed in the fixed manual regeneration mode, but the invention is not limited thereto. For example, the control may be performed in an auto-regeneration mode.

While the embodiment has been described, the embodiment is not limited to the above-described content. Further, the above-described components include a component which can be easily supposed by the person skilled in the art, a component which has substantially the same configuration, and a component which is in a so-called equivalent range. In addition, the above-described components can be appropriately combined with one another. Furthermore, various omissions, substitutions, or modifications of the components can be made without departing from the spirit of the embodiment.

### REFERENCE SIGNS LIST

1 EXCAVATOR

5 UPPER SWINGING BODY

17 INTERNAL COMBUSTION ENGINE

18 HYDRAULIC PUMP

19 GENERATOR MOTOR

22 ELECTRICAL STORAGE DEVICE

23 HYBRID CONTROLLER

26L, 26R OPERATION LEVER

30 ENGINE CONTROLLER

23C GENERATION CONTROL UNIT

23M STORAGE UNIT

23P PROCESSING UNIT

23S THRESHOLD VALUE SETTING UNIT

23IO INPUT/OUTPUT UNIT

23J DETERMINATION UNIT

33 PUMP CONTROLLER

36 ENGINE

40 EXHAUST GAS TREATMENT DEVICE

41 PARTICLE TRAPPING FILTER

42 REDUCING CATALYST

1. A control device for a hybrid work machine including an internal combustion engine which includes an exhaust gas treatment device, a generator motor which is connected to an output shaft of the internal combustion engine, and an electrical storage device which stores electric power generated by the generator motor or supplies electric power to the generator motor, the control device controlling the hybrid work machine comprising:
a determination unit which determines whether the hybrid work machine is in a regeneration state in which a regeneration is performed by the exhaust gas treatment device;
a threshold value setting unit which sets a threshold value for starting a generation of power by the generator motor to a minimum generation torque as a lower limit value when the determination unit determines that the regeneration is performed by the exhaust gas treatment device; and
a generation control unit which controls the generator motor based on the threshold value set by the threshold value setting unit.

2. A control device for a hybrid work machine including an internal combustion engine which includes an exhaust gas treatment device, a generator motor which is connected to an output shaft of the internal combustion engine, and an electrical storage device which stores electric power generated by the generator motor or supplies electric power to the generator motor, the control device controlling the hybrid work machine comprising:
a determination unit which determines whether the hybrid work machine is in a regeneration state in which a regeneration is performed by the exhaust gas treatment device;
a threshold value setting unit which sets a charging request voltage value as a threshold value for starting a charging of the electrical storage device to a predetermined first voltage value when the determination unit determines that the exhaust gas treatment device stops the regeneration and sets the charging request voltage value to a second voltage value higher than the first voltage value when the determination unit determines that the exhaust gas treatment device performs the regeneration; and
a generation control unit which controls the generator motor based on the charging request voltage value set in the threshold value setting unit.

3. The control device for the hybrid work machine according to claim 2,
wherein the second voltage value is a voltage value charged when the generator motor generates power at a generation torque of a lower-limit setting value.

4. The control device for the hybrid work machine according to claim 2,
wherein the determination unit determines the regeneration state when a predetermined regeneration instruction is input, a particle accumulation amount of the exhaust gas treatment device is equal to or larger than a predetermined value, a rotation speed instruction value for instructing a rotation speed of the internal combustion engine is smaller than a predetermined value, a rotation speed difference between the rotation speed of the internal combustion engine and the rotation speed instruction value is within a predetermined rotation speed, and the hybrid work machine prohibits an operation of a working implement.

5. The control device for the hybrid work machine according to claim 2, further comprising:
a rotation speed control unit which controls a rotation speed of the internal combustion engine based on a load of a working implement provided in the hybrid work machine.

6. A hybrid work machine comprising:
an internal combustion engine which includes an exhaust gas treatment device;
a generator motor which is connected to an output shaft of the internal combustion engine;
an electrical storage device which stores electric power generated by the generator motor or supplies electric power to the generator motor; and
the control device for the hybrid work machine according to any one of claim 2 which controls the internal combustion engine, the generator motor, and the electrical storage device.

7. A control method for a hybrid work machine including an internal combustion engine which includes an exhaust gas treatment device, a generator motor which is connected to an output shaft of the internal combustion engine, and an electrical storage device which stores electric power generated by the generator motor or supplies electric power to the generator motor, the control method for the hybrid work machine comprising:
determining whether the hybrid work machine is in a regeneration state in which a regeneration is performed by the exhaust gas treatment device;
setting a threshold value for starting a generation of power by the generator motor to a minimum generation torque as a lower limit value when it is determined that the exhaust gas treatment device performs a regeneration; and
controlling the generator motor based on the set threshold value.

8. The control device for the hybrid work machine according to claim 1,
wherein the determination unit determines the regeneration state when a predetermined regeneration instruction is input, a particle accumulation amount of the exhaust gas treatment device is equal to or larger than a predetermined value, a rotation speed instruction value for instructing a rotation speed of the internal combustion engine is smaller than a predetermined value, a rotation speed difference between the rotation speed of the internal combustion engine and the rotation speed instruction value is within a predetermined rotation speed, and the hybrid work machine prohibits an operation of a working implement.

9. The control device for the hybrid work machine according to claim 1, further comprising:
a rotation speed control unit which controls a rotation speed of the internal combustion engine based on a load of a working implement provided in the hybrid work machine.

10. A hybrid work machine comprising:
an internal combustion engine which includes an exhaust gas treatment device;
a generator motor which is connected to an output shaft of the internal combustion engine;
an electrical storage device which stores electric power generated by the generator motor or supplies electric power to the generator motor; and
the control device for the hybrid work machine according to any one of claim 1 which controls the internal combustion engine, the generator motor, and the electrical storage device.
